(19) United States
(12) Patent Application Publication
(10) Pub. No.: US 2026/0093046 A1
(43) Pub. Date: Apr. 2, 2026

(54) EXTERNAL SENSOR DATA USAGE FOR IMPROVED DEAD RECKONING

(71) Applicant: QUALCOMM Incorporated, San Diego, CA (US)

(72) Inventors: Neha NAGORI, Saratoga, CA (US); William MORRISON, San Francisco, CA (US); Himanshu SHAH, Milpitas, CA (US); Gautam NIRULA, Pleasanton, CA (US); Hsiao Chien LIANG, San Jose, CA (US); Liping XU, Shanghai (CN)

(21) Appl. No.: 19/113,611

(22) PCT Filed: Dec. 8, 2022
(86) PCT No.: PCT/CN2022/137447

§ 371 Date: Mar. 20, 2025

(51) Int. Cl. G01S 19/47; G01C 21/30

(52) U.S. Cl. CPC G01S 19/47; G01C 21/30

(57) ABSTRACT

Disclosed are techniques for wireless positioning. In an aspect, a user equipment (UE) determines a validated heading of the UE, wherein the validated heading is determined based on at least navigational map data stored in a memory of the UE, and determines a dead reckoning position estimate of the UE based on at least the validated heading and sensor information from one or more environmental sensors of the UE.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless positioning performed by a user equipment (UE) includes determining a validated heading of the UE, wherein the validated heading is determined based on at least navigational map data stored in a memory of the UE; and determining a dead reckoning position estimate of the UE based on at least the validated heading and sensor information from one or more environmental sensors of the UE.

In an aspect, a user equipment (UE) includes a memory; at least one transceiver; and at least one processor communicatively coupled to the memory and the at least one transceiver, the at least one processor configured to: determine a validated heading of the UE, wherein the validated heading is determined based on at least navigational map data stored in a memory of the UE; and determine a dead reckoning position estimate of the UE based on at least the validated heading and sensor information from one or more environmental sensors of the UE.

In an aspect, a user equipment (UE) includes means for determining a validated heading of the UE, wherein the validated heading is determined based on at least navigational map data stored in a memory of the UE; and means for determining a dead reckoning position estimate of the UE based on at least the validated heading and sensor information from one or more environmental sensors of the UE.

In an aspect, a non-transitory computer-readable medium stores computer-executable instructions that, when executed by a user equipment (UE), cause the UE to: determine a validated heading of the UE, wherein the validated heading is determined based on at least navigational map data stored in a memory of the UE; and determine a dead reckoning position estimate of the UE based on at least the validated heading and sensor information from one or more environmental sensors of the UE.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIG. 3 illustrates an example user equipment (UE) architecture, according to various aspects of the disclosure.

FIG. 4 illustrates an example on-board computer architecture, according to various aspects of the disclosure.

FIG. 5 is a diagram illustrating a scenario in which a UE is navigating through a tunnel, according to aspects of the disclosure.

FIG. 6 illustrates an example architecture of a UE navigation system, according to aspects of the disclosure.

FIG. 7 illustrates an example method of operating the UE navigation system illustrated in FIG. 6, according to aspects of the disclosure.

FIG. 8 illustrates an example method of wireless positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal”refers to a wireless signal or an RF signal.

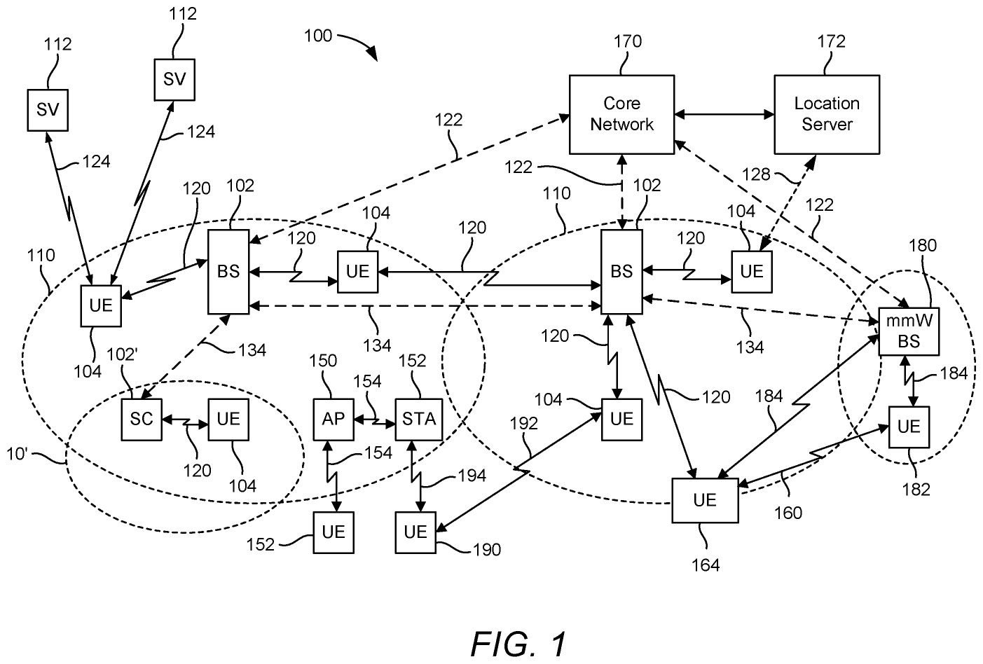

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mm W/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

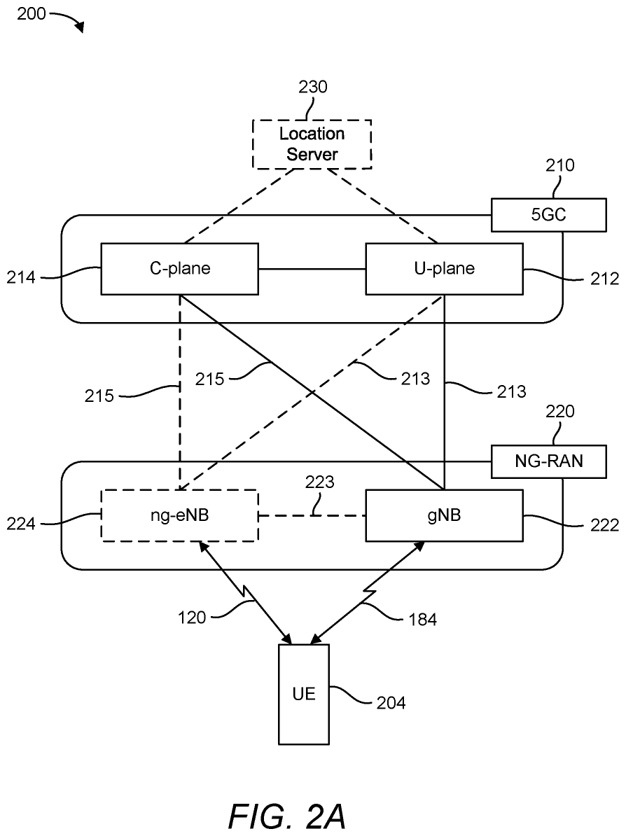

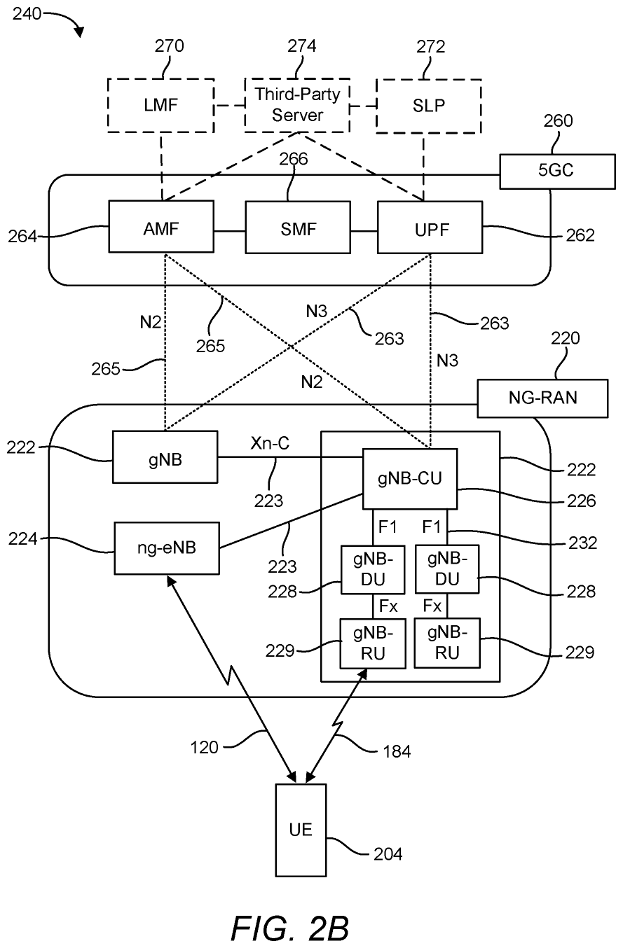

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., a smartphone or a V-UE).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

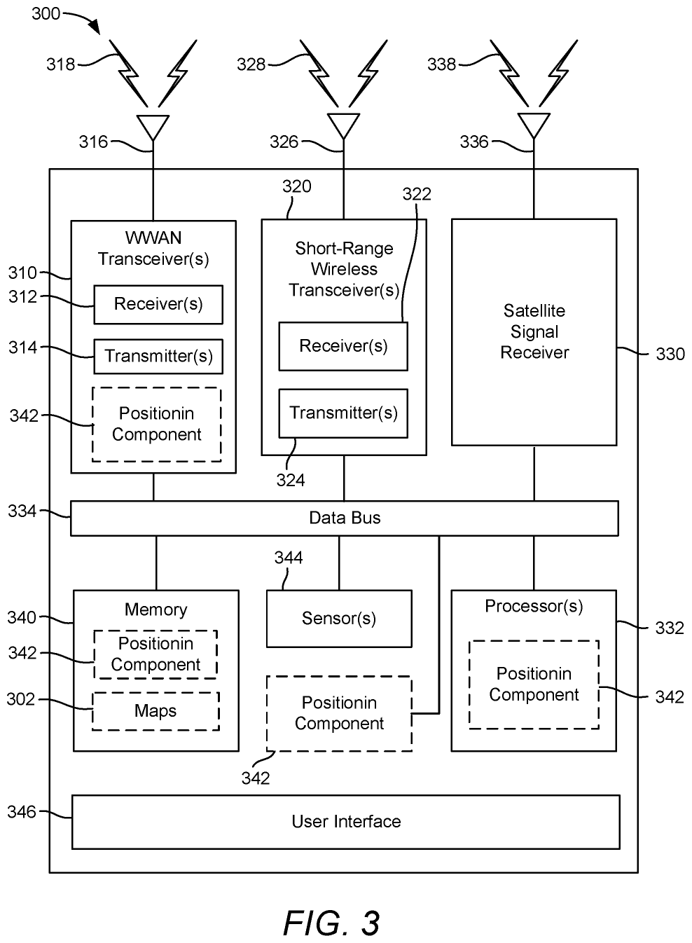

FIG. 3 illustrates several example components (represented by corresponding blocks) that may be incorporated into a UE 300 (which may correspond to any of the UEs described herein). It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 300 includes one or more wireless wide area network (WWAN) transceivers 310 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 310 may each be connected to one or more antennas 316 for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 310 may be variously configured for transmitting and encoding signals 318 (e.g., messages, indications, information, and so on) and, conversely, for receiving and decoding signals 318 (e.g., messages, indications, information, pilots, and so on) in accordance with the designated RAT. Specifically, the one or more WWAN transceivers 310 include one or more transmitters 314 for transmitting and encoding signals 318 and one or more receivers 312 for receiving and decoding signals 318.

The UE 300 also includes, at least in some cases, one or more short-range wireless transceivers 320. The one or more short-range wireless transceivers 320 may be connected to one or more antennas 326 and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The one or more short-range wireless transceivers 320 may be variously configured for transmitting and encoding signals 328 (e.g., messages, indications, information, and so on) and, conversely, for receiving and decoding signals 328 (e.g., messages, indications, information, pilots, and so on) in accordance with the designated RAT. Specifically, the one or more short-range wireless transceivers 320 include one or more transmitters 324 for transmitting and encoding signals 328 and one or more receivers 322 for receiving and decoding signals 328. As specific examples, the one or more short-range wireless transceivers 320 may be Wi-Fi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 300 also includes, at least in some cases, a satellite signal receiver 330. The satellite signal receiver 330 may be connected to one or more antennas 336 and may provide means for receiving and/or measuring satellite positioning/communication signals 338. Where the satellite signal receiver 330 is a satellite positioning system receiver, the satellite positioning/communication signals 338 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receiver 330 is a non-terrestrial network (NTN) receiver, the satellite positioning/communication signals 338 may be communication signals (e.g., carrying control and/or user data) originating from a 5G network. The satellite signal receiver 330 may comprise any suitable hardware and/or software for receiving and processing satellite positioning/communication signals 338. The satellite signal receiver 330 may request information and operations as appropriate from the other systems, and, at least in some cases, perform calculations to determine locations of the UE 300 using measurements obtained by any suitable satellite positioning system algorithm.

A transceiver may be configured to communicate over a wired or wireless link. A transceiver (whether a wired transceiver or a wireless transceiver) includes transmitter circuitry (e.g., transmitters 314, 324) and receiver circuitry (e.g., receivers 312, 322). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry (e.g., transmitters 314, 324) may include or be coupled to a plurality of antennas (e.g., antennas 316, 326), such as an antenna array, that permits the respective apparatus (e.g., UE 300) to perform transmit “beamforming,” as described herein. Similarly, wireless receiver circuitry (e.g., receivers 312, 322) may include or be coupled to a plurality of antennas (e.g., antennas 316, 326), such as an antenna array, that permits the respective apparatus (e.g., UE 300) to perform receive beamforming, as described herein. In an aspect, the transmitter circuitry and receiver circuitry may share the same plurality of antennas (e.g., antennas 316, 326), such that the respective apparatus can only receive or transmit at a given time, not both at the same time. A wireless transceiver (e.g., the one or more WWAN transceivers 310, the one or more short-range wireless transceivers 320) may also include a network listen module (NLM) or the like for performing various measurements.

As used herein, the various wireless transceivers (e.g., transceivers 310, 320) and wired transceivers may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 300) and a base station will generally relate to signaling via a wireless transceiver.

The UE 300 also includes other components that may be used in conjunction with the operations as disclosed herein. The UE 300 includes one or more processors 332 for providing functionality relating to, for example, wireless communication, and for providing other processing functionality. The one or more processors 332 may therefore provide means for processing, such as means for determining, means for calculating, means for receiving, means for transmitting, means for indicating, etc. In an aspect, the one or more processors 332 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 300 includes memory circuitry implementing memory 340 (e.g., each including a memory device) for maintaining information (e.g., information indicative of reserved resources, thresholds, parameters, and so on). The memory 340 may therefore provide means for storing, means for retrieving, means for maintaining, etc. In some cases, the UE 300 may include a positioning component 342. The positioning component 342 may be hardware circuits that are part of or coupled to the one or more processors 332 that, when executed, cause the UE 300 to perform the functionality described herein. In other aspects, the positioning component 342 may be external to the processors 332 (e.g., part of a modem processing system, integrated with another processing system, etc.). Alternatively, the positioning component 342 may be a memory module stored in the memory 340 that, when executed by the one or more processors 332 (or a modem processing system, another processing system, etc.), cause the UE 300 to perform the functionality described herein. FIG. 3 illustrates possible locations of the positioning component 342, which may be, for example, part of the one or more WWAN transceivers 310, the memory 340, the one or more processors 332, or any combination thereof, or may be a standalone component.

In an aspect, the UE 300 may utilize the one or more WWAN transceivers 310 and/or the one or more short-range wireless transceivers 320 to download one or more maps 302 that can then be stored in memory 340 and used to obtain navigational map data for vehicle navigation. Map(s) 302 may be one or more high definition (HD) maps, which may provide accuracy in the 7-10 cm absolute ranges, highly detailed inventories of all stationary physical assets related to roadways and pathways, such as road lanes, road edges, shoulders, dividers, traffic signals, signage, paint markings, poles, and other data useful for the safe navigation of roadways and intersections by the UE 300. The information about the road lanes may include the number, width, type (e.g., high-occupancy vehicle (HOV) or non-HOV), traffic direction, etc. of the lanes. Alternatively, the map(s) 302 may be more generic, or compressed, with roadways represented as linear segments and/or road headings. Thus, the navigational map data obtainable from map(s) 302 may range from the locations and dimensions of stationary physical assets related to roadways and pathways to only road headings.

In addition, the navigational map data obtained from map(s) 302 may vary based on the type of navigation and/or the type of the UE 300. For example, the navigational map data for a handheld UE may be less detailed than the navigational map data for a V-UE. As another example, the navigational map data for pedestrian walkways may be more detailed than the navigational map data for public transportation routes. Similarly, the level of detail of map(s) 302 (e.g., HD maps, road segments, road headings) and/or the navigational map data obtained from map(s) 302 may depend on the type of the UE 300 downloading and accessing map(s) 302 or the type of navigation being accessed by the UE 300.

The UE 300 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include one or more accelerometers (e.g., micro-electrical mechanical systems (MEMS) devices), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems. Note that at least the accelerometer and gyroscope may be referred to as “inertial” sensors.

The various components of the UE 300 may be communicatively coupled to each other over a data bus 334. In an aspect, the data bus 334 may form, or be part of, a communication interface of the UE 300.

In addition, the UE 300 includes a user interface 346 providing means for providing indications (e.g., audible and/or visual indications) to a user and/or for receiving user input (e.g., upon user actuation of a sensing device such a keypad, a touch screen, a microphone, and so on).

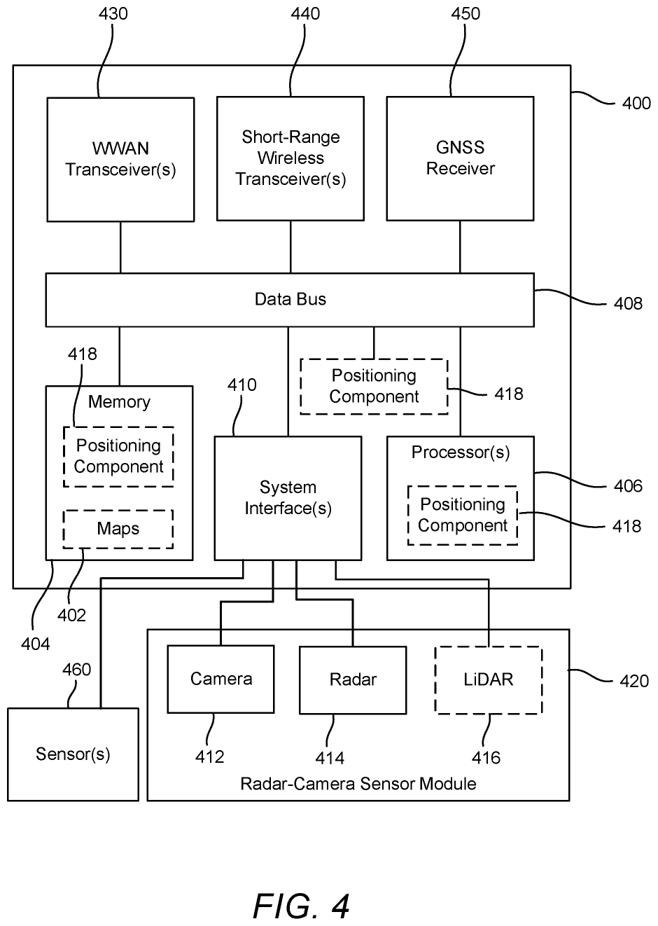

FIG. 4 illustrates an example architecture of an on-board computer (OBC) 400 of a vehicle, according to various aspects of the disclosure. In an aspect, the OBC 400 may be part of an advanced driver assistance system (ADAS) or automated driving system (ADS) of the vehicle. The OBC 400 may also be the V-UE of the vehicle. The OBC 400 includes a non-transitory computer-readable storage medium, i.e., memory 404, and one or more processors 406 in communication with the memory 404 via a data bus 408. The memory 404 includes one or more storage modules storing computer-readable instructions executable by the one or more processors 406 to perform the functions of the OBC 400 described herein. For example, the one or more processors 406 in conjunction with the memory 404 may implement the various operations described herein.

One or more radar-camera sensor modules 420 are coupled to the OBC 400 (only one is shown in FIG. 4 for simplicity). In some aspects, the radar-camera sensor module 420 includes at least one camera 412, at least one radar 414, and an optional light detection and ranging (LiDAR) sensor 416. The OBC 400 also includes one or more system interfaces 410 connecting the one or more processors 406, by way of the data bus 408, to the radar-camera sensor module 420 and, optionally, other vehicle sub-systems (not shown).

In an aspect, the camera 412 may capture image frames (also referred to herein as camera frames) of the scene within the viewing area of the camera 412 at some periodic rate. Likewise, the radar 414 may capture radar frames of the scene within the viewing area of the radar 414 at some periodic rate. The periodic rates at which the camera 412 and the radar 414 capture their respective frames may be the same or different. Each camera and radar frame may be timestamped. Thus, where the periodic rates are different, the timestamps can be used to select simultaneously, or nearly simultaneously, captured camera and radar frames for further processing (e.g., fusion).

The OBC 400 also includes, at least in some cases, one or more wireless wide area network (WWAN) transceivers 430 configured to communicate via one or more wireless communication networks (not shown), such as an NR network, an LTE network, a Global System for Mobile communication (GSM) network, and/or the like. The one or more WWAN transceivers 430 may be connected to one or more antennas (not shown) for communicating with other network nodes, such as other V-UEs, pedestrian UEs, infrastructure access points, roadside units (RSUs), base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 430 may be variously configured for transmitting and encoding signals (e.g., messages, indications, information, and so on), and, conversely, for receiving and decoding signals (e.g., messages, indications, information, pilots, and so on) in accordance with the designated RAT.

The OBC 400 also includes, at least in some cases, one or more short-range wireless transceivers 440 (e.g., a Wi-Fi transceiver, a Bluetooth transceiver, etc.). The one or more short-range wireless transceivers 440 may be connected to one or more antennas (not shown) for communicating with other network nodes, such as other V-UEs, pedestrian UEs, infrastructure access points, RSUs, etc., via at least one designated RAT (e.g., cellular vehicle-to-everything (C-V2X), IEEE 802.11p (also known as wireless access for vehicular environments (WAVE)), dedicated short-range communication (DSRC), etc.) over a wireless communication medium of interest. The one or more short-range wireless transceivers 440 may be variously configured for transmitting and encoding signals (e.g., messages, indications, information, and so on), and, conversely, for receiving and decoding signals (e.g., messages, indications, information, pilots, and so on) in accordance with the designated RAT.

As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a receiver chip or similar circuitry simply providing low-level sniffing).

The OBC 400 also includes, at least in some cases, a global navigation satellite system (GNSS) receiver 450. The GNSS receiver 450 may be connected to one or more antennas (not shown) for receiving satellite signals. The GNSS receiver 450 may comprise any suitable hardware and/or software for receiving and processing GNSS signals. The GNSS receiver 450 requests information and operations as appropriate from the other systems, and performs the calculations necessary to determine the vehicle's position using measurements obtained by any suitable GNSS algorithm.

In an aspect, the OBC 400 may utilize the one or more WWAN transceivers 430 and/or the one or more short-range wireless transceivers 440 to download one or more maps 402 that can then be stored in memory 404 and used to obtain navigational map data for vehicle navigation. Map(s) 402 may be one or more HD maps, which may provide accuracy in the 7-10 cm absolute ranges, highly detailed inventories of all stationary physical assets related to roadways, such as road lanes, road edges, shoulders, dividers, traffic signals, signage, paint markings, poles, and other data useful for the safe navigation of roadways and intersections by the vehicle. Map(s) 402 may also provide electronic horizon predictive awareness, which enables the vehicle to know what lies ahead. The information about the road lanes may include the number, width, type (e.g., high-occupancy vehicle (HOV) or non-HOV), traffic direction, etc. of the lanes. Alternatively, the map(s) 402 may be more generic, or compressed, with roadways represented as linear segments and/or road headings. Thus, the navigational map data obtainable from map(s) 302 may range from the locations and dimensions of stationary physical assets related to roadways and pathways to only road headings.

One or more sensors 460 of the vehicle may be coupled to the one or more processors 406 via the one or more system interfaces 410. The one or more sensors 460 may provide means for sensing or detecting information related to the state and/or environment of the vehicle, such as speed, heading (e.g., compass heading), headlight status, gas mileage, etc. By way of example, the one or more sensors 460 may include an odometer a speedometer, a tachometer, an accelerometer (e.g., a MEMS device), a gyroscope, a geomagnetic sensor (e.g., a compass), an altimeter (e.g., a barometric pressure altimeter), etc. Although shown as located outside the OBC 400, some of these sensors 460 may be located on the OBC 400 and some may be located elsewhere in the vehicle.

The OBC 400 may further include a positioning component 418. The positioning component 418 may be a hardware circuit that is part of or coupled to the one or more processors 406 that, when executed, causes the OBC 400 to perform the functionality described herein. In other aspects, the positioning component 418 may be external to the one or more processors 406 (e.g., part of a positioning processing system, integrated with another processing system, etc.). Alternatively, the positioning component 418 may be one or more memory modules stored in the memory 404 that, when executed by the one or more processors 406 (or positioning processing system, another processing system, etc.), cause the OBC 400 to perform the functionality described herein. As a specific example, the positioning component 418 may comprise a plurality of positioning engines, a positioning engine aggregator, a sensor fusion module, and/or the like. FIG. 4 illustrates possible locations of the positioning component 418, which may be, for example, part of the memory 404, the one or more processors 406, or any combination thereof, or may be a standalone component.

Although not shown, the OBC 400 may include or be coupled to a user interface (e.g., a touchscreen) for providing indications (e.g., audible and/or visual indications) to a user and/or for receiving user input (e.g., upon user actuation of a sensing device such a keypad, a touch screen, a microphone, and so on).

For convenience, the UE 300 and the OBC 400 are shown in FIGS. 3 and 4, respectively, as including various components that may be configured according to the various examples described herein. It will be appreciated, however, that the illustrated components may have different functionality in different designs. In particular, various components in FIG. 3 are optional in alternative configurations and the various aspects include configurations that may vary due to design choice, costs, use of the device, or other considerations. For example, a particular implementation of UE 300 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. The same is true for the OBC 400. For brevity, illustration of the various alternative configurations is not provided herein, but would be readily understandable to one skilled in the art.

The components of FIGS. 3 and 4 may be implemented in various ways. In some implementations, the components of FIGS. 3 and 4 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 302 to 346 may be implemented by processor and memory component(s) of the UE 300 (e.g., by execution of appropriate code and/or by appropriate configuration of processor components). For simplicity, various operations, acts, and/or functions are described herein as being performed “by a UE.” However, as will be appreciated, such operations, acts, and/or functions may actually be performed by specific components or combinations of components of the UE 300, such as the one or more processors 332, the one or more transceivers 310 and 320, the memory 340, the positioning component 342, etc.

A UE may estimate its position for navigation using sensor-based positioning (e.g., using sensors 344) and/or GNSS-based positioning (e.g., using satellite signal receiver 330). Sensor-based positioning is also referred to as “inertial navigation” or “dead reckoning.” Dead reckoning is the process of calculating the current position of the UE by using a previously determined position of the UE and then incorporating estimates of speed, heading direction, and course over the elapsed time between the previous and current position fixes.

Some UE navigation systems (e.g., vehicle navigation systems) can use both dead reckoning and GNSS-based positioning to increase positioning accuracy. For example, challenging GNSS conditions, such when the UE is surrounded by tall buildings, in a tunnel, in a parking garage, under heavy tree canopy, etc., may result in degraded GNSS-based positioning performance. Dead reckoning can be used to continue positioning and/or navigating the UE during these outages in GNSS service.

Dead reckoning may be subject to significant errors of approximation, however. For precise position information, both speed and direction (heading) need to be accurately known during travel. Notably, dead reckoning does not account for directional drift during travel. These errors tend to compound over greater distances, making dead reckoning a difficult method of navigation for longer journeys. For example, if displacement is measured by the number of rotations of a wheel of a vehicle, any discrepancy between the actual and assumed traveled distance per rotation, due perhaps to slippage or surface irregularities, will be a source of error. As each position estimate is relative to the previous one, errors are cumulative over time.

The accuracy of dead reckoning can be increased significantly by using other positioning methods (e.g., GNSS) to obtain a new position fix during navigation. Accurate estimation of device attitude (i.e., orientation) is needed for positioning a UE using a combination of GNSS-based positioning and sensor-based positioning. The presence of GNSS-based positioning permits calibration of the sensor biases for the sensor-based positioning to enable more accurate attitude estimation. As such, the inability to calibrate the sensor biases in challenged GNSS conditions may result in degraded dead reckoning performance. The degraded dead reckoning performance is caused by larger sensor mechanization errors in the presence of inaccurate sensor bias estimates from GNSS.

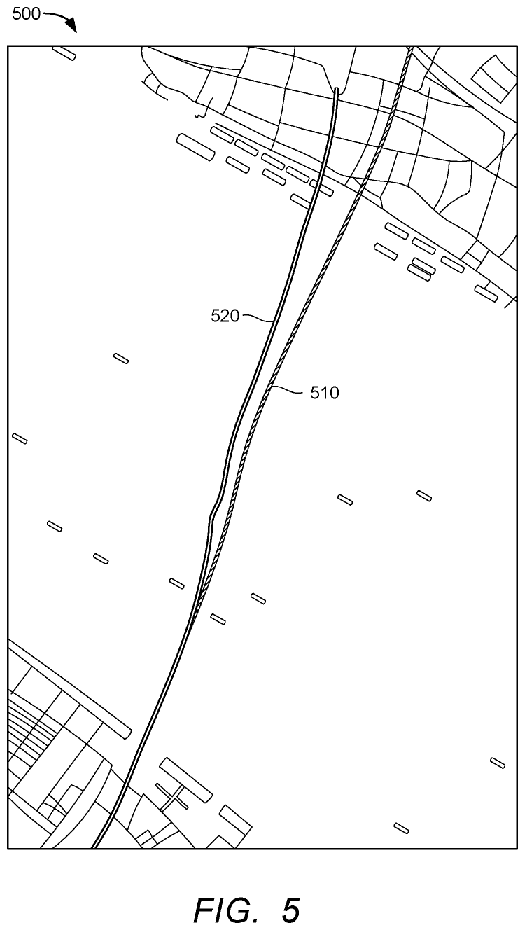

FIG. 5 is a diagram 500 illustrating a scenario in which a UE is navigating through a tunnel, according to aspects of the disclosure. In the example of FIG. 5, the tunnel provides a roadway under a harbor. The UE may be a handheld UE, such as a smartphone, being carried by a user in a vehicle or an OBC of the vehicle, such as OBC 400. As shown in FIG. 5, the tunnel follows path 510, but due to the lack of GNSS service within the tunnel and the inability to calibrate the sensor biases based on GNSS, the UE has calculated its position as following path (or route) 520.

The present disclosure provides techniques to use external sensor data to improve dead reckoning navigation. At a high level, when GNSS measurements are not available, the position fixes from the dead reckoning navigation system can be compared to a heading of the UE determined from navigational map data (or simply “map data”) to adjust the position estimates from the dead reckoning navigation system. More specifically, the map data heading is used to improve attitude estimation. The attitude (i.e., orientation) of the UE is estimated by deriving a roll estimate and a pitch estimate from extended Kalman filter (EKF) states and a yaw estimate from the map heading. The velocity (speed) estimate of the EKF state is adjusted with the map heading and the position state is propagated using the sensor-based position estimate and the updated attitude estimate.

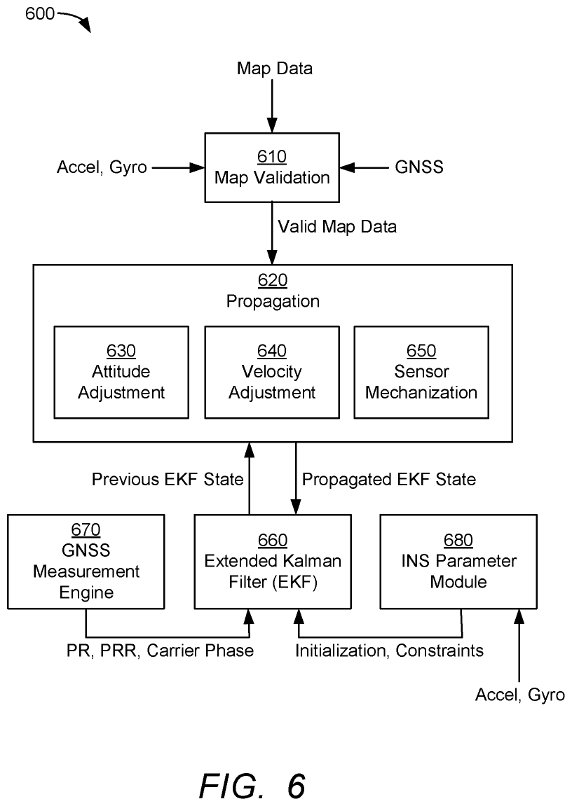

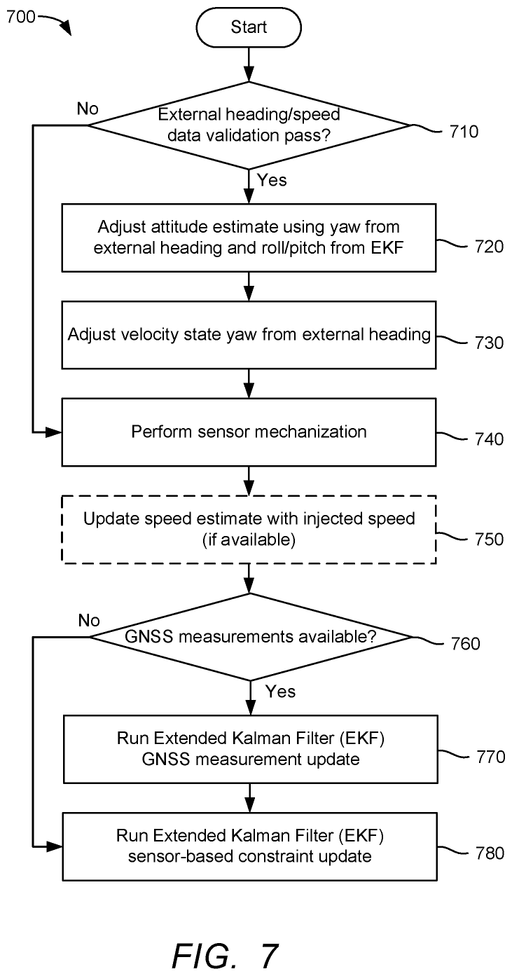

FIG. 6 illustrates an example architecture of a UE navigation system 600, according to aspects of the disclosure. The UE may be a handheld UE, such as a smartphone, or an OBC of a vehicle, such as OBC 400. FIG. 7 illustrates an example method 700 of operating the UE navigation system 600, according to aspects of the disclosure.

As shown in FIG. 6, the map validation block 610 receives navigational map data (e.g., from maps 302, 402), GNSS information (e.g., from satellite signal receiver 330, GNSS receiver 450), and accelerometer and gyroscope information (e.g., from sensors 344, 460). As discussed above, the navigational map data may be highly detailed (as in the case of HD maps) or simply indicate the heading of the roadway. In addition, the type and/or detail of the map data may depend on the type of the UE on which the UE navigation system 600 is implemented and/or the type of navigation (e.g., pedestrian, bicycle, vehicle, public transportation, etc.). In any case, the UE navigation system 600 should be able to determine a heading of the UE from the navigational map data (referred to as the “map heading”). The GNSS information and the inertial sensor information (i.e., the accelerometer and gyroscope information) also indicate the heading and speed of the UE.

At stage 710, the map validation block 610 determines the validity of the map data based on the GNSS information and the accelerometer and gyroscope information (i.e., the heading and speed of the UE). That is, the map validation block 610 determines whether the heading of the UE determined from the map data (the map heading) is consistent with the heading and speed data determined from the GNSS information and the inertial sensor information.

Note that at least the map heading should be validated using both GNSS and sensor information. More specifically, when GNSS information is available, it is latched onto. When it is not available, the latched heading is simply propagated using the motion sensors (e.g., accelerometer and gyroscope), and this is used to validate the map heading.

In an aspect, although FIG. 6 illustrates the speed and heading being determined based on accelerometer and gyroscope information, as will be appreciated, other external sensors may be used. For example, the speed and heading can also be estimated from camera data (e.g., camera frames from camera 412), radar data (e.g., radar frames from radar 414), and/or lidar data (e.g., lidar frames from LiDAR sensor 416).

The validated map data (e.g., the validated heading) is passed to a propagation block 620. The propagation block includes an attitude adjustment block 630, a velocity adjustment block 640, and a sensor mechanization block 650. The propagation block 620 additionally takes as input accelerometer and gyroscope information (e.g., from sensors 344, 460) and the previous EKF state. Based on this information, at stage 720, the attitude adjustment block 630 updates the attitude (i.e., orientation) estimate of the UE using yaw (i.e., side to side motion of the UE) information from the external map heading and roll and/or pitch (i.e., up and down motion of the UE) information from the EKF block 660. More specifically, the updated attitude is estimated by deriving roll and/or pitch from the EKF state(s) and yaw from the map heading (i.e., from the validated map data).

At stage 730, the velocity adjustment block 640 updates the velocity/speed estimate of the UE. The velocity of the EKF state is adjusted based on the map heading validated at stage 710. The method 700 then proceeds to stage 740. The method 700 also proceeds to stage 740 if the external heading and/or speed is not validated at stage 720.

At stage 740, based on these updates, the sensor mechanization block 650 performs sensor mechanization and outputs a propagated EKF state to the EKF block 660. Sensor mechanization is the process of keeping track of position and direction of travel using inertial sensors. As such, the propagated EKF state indicates the new position estimate of the UE determined based on the updated attitude and velocity from the attitude adjustment block 630 and the velocity adjustment block 640, respectively.

At stage 750, based on the sensor mechanization performed at stage 740, the velocity/speed estimate is updated with the injected speed (if available). This stage is performed after the sensor mechanization block 650 and before the EKF block 660.

In addition to the propagated EKF state from the propagation block 620, the EKF block 660 takes as input information from a GNSS measurement engine 670 (e.g., satellite signal receiver 330, GNSS receiver 450), if determined to be available at stage 760, and an inertial navigation system (INS) parameter module 680. The input from the GNSS measurement engine 670 may include pseudo range (PR), pseudo range rate (PRR), and carrier phase. The input from the INS parameter module 680 may include initialization and constraints parameters. The INS parameter module 680 itself takes as input accelerometer and gyroscope information (e.g., from sensors 344, 460). The initialization and constraints parameters constrain the sensor-based propagation from the propagation block 620 using an absolute user motion trajectory.

At stage 770, based on the received information, the EKF block 660 fuses, or integrates, the GNSS measurements from the GNSS measurement engine 670 and the sensor-based position fix from the propagation block 620 to output an EKF state to the propagation block 620. The EKF state represents the position of the UE as calculated by the EKF block 660 based on the sensor information and the GNSS measurements.

The GNSS-based EKF update at stage 770 cannot be made if GNSS information is not available. Thus, at stage 780, if GNSS information is not available, a measurement update is performed using constraints from the INS parameter module 680 to propagate the previous GNSS state.

The method 700 illustrated in FIG. 7 can be performed any time the UE is navigating, whether GNSS is available or not. However, as will be appreciated, the method 700 provides improved navigation results when GNSS service is not available or reliable.

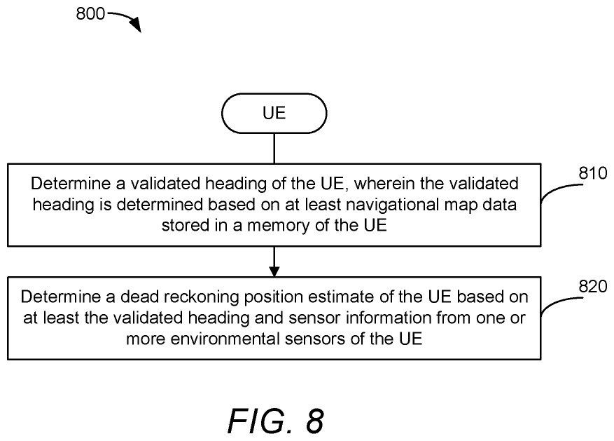

FIG. 8 illustrates an example method 800 of wireless positioning, according to aspects of the disclosure. In an aspect, method 800 may be performed by a UE (e.g., any of the UEs described herein).

At 810, the UE determines a validated heading of the UE, wherein the validated heading is determined based on at least navigational map data stored in a memory of the UE. In an aspect, operation 810 may be performed by the one or more WWAN transceivers 310, the one or more processors 332, memory 340, and/or positioning component 342, any or all of which may be considered means for performing this operation. In an aspect, operation 810 may be performed by the one or more WWAN transceivers 430, the one or more processors 406, memory 404, and/or positioning component 418, any or all of which may be considered means for performing this operation.

At 820, the UE determines a dead reckoning position estimate of the UE based on at least the validated heading and sensor information from one or more environmental sensors of the UE. In an aspect, operation 820 may be performed by the one or more WWAN transceivers 310, the one or more processors 332, memory 340, and/or positioning component 342, any or all of which may be considered means for performing this operation. In an aspect, operation 820 may be performed by the one or more WWAN transceivers 430, the one or more processors 406, memory 404, and/or positioning component 418, any or all of which may be considered means for performing this operation.

As will be appreciated, a technical advantage of the method 800 is improved navigation results.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless positioning performed by a user equipment (UE), comprising: determining a validated heading of the UE, wherein the validated heading is determined based on at least navigational map data stored in a memory of the UE; and determining a dead reckoning position estimate of the UE based on at least the validated heading and sensor information from one or more environmental sensors of the UE.

Clause 2. The method of clause 1, wherein determining the dead reckoning position estimate comprises: determining an estimate of an attitude of the UE, wherein the estimate of the attitude is determined based on a roll estimate, a pitch estimate, and a yaw estimate of the UE, and wherein the yaw estimate is based on the validated heading; and determining the dead reckoning position estimate based on at least the sensor information and the estimate of the attitude.

Clause 3. The method of clause 2, wherein the roll estimate and the pitch estimate are determined based on one or more extended Kalman filter (EKF) states.

Clause 4. The method of clause 3, wherein a velocity estimate of the one or more EKF states is updated based on the validated heading.

Clause 5. The method of any of clauses 3 to 4, wherein a position estimate of the one or more EKF states is propagated using the sensor information and the estimate of the attitude.

Clause 6. The method of any of clauses 3 to 5, wherein the one or more EKF states are based on one or more initialization and constraints parameters.

Clause 7. The method of clause 6, wherein: the one or more initialization and constraints parameters comprise a trajectory of the UE, and the trajectory of the UE is based on the sensor information.

Clause 8. The method of any of clauses 1 to 7, wherein the validated heading is further based on global navigation satellite system (GNSS) measurements obtained by the UE and the sensor information from the one or more environmental sensors of the UE.

Clause 9. The method of clause 8, wherein determining the validated heading of the UE comprises: determining that a first heading of the UE determined based on the navigational map data is consistent with a second heading of the UE determined based on the GNSS measurements and the sensor information.

Clause 10. The method of any of clauses 8 to 9, wherein the GNSS measurements comprise: pseudo range (PR), pseudo range rate (PRR), carrier phase, or any combination thereof.

Clause 11. The method of any of clauses 1 to 10, wherein the one or more environmental sensors comprise: an accelerometer, a gyroscope, a camera, a radar, a lidar, or any combination thereof.

Clause 12. The method of any of clauses 1 to 11, further comprising: displaying a route of the UE on a user interface of the UE, wherein the route of the UE is overlaid on a map displayed on the user interface of the UE, and wherein the route of the UE includes the dead reckoning position estimate of the UE.

Clause 13. The method of any of clauses 1 to 12, wherein the UE does not have GNSS service during the determination of the dead reckoning position estimate.

Clause 14. The method of any of clauses 1 to 13, wherein the UE comprises: a handheld UE, or an on-board computer of a vehicle.

Clause 15. A user equipment (UE), comprising: a memory; at least one transceiver; and at least one processor communicatively coupled to the memory and the at least one transceiver, the at least one processor configured to: determine a validated heading of the UE, wherein the validated heading is determined based on at least navigational map data stored in a memory of the UE; and determine a dead reckoning position estimate of the UE based on at least the validated heading and sensor information from one or more environmental sensors of the UE.

Clause 16. The UE of clause 15, wherein the at least one processor configured to determine the dead reckoning position estimate comprises the at least one processor configured to: determine an estimate of an attitude of the UE, wherein the estimate of the attitude is determined based on a roll estimate, a pitch estimate, and a yaw estimate of the UE, and wherein the yaw estimate is based on the validated heading; and determine the dead reckoning position estimate based on at least the sensor information and the estimate of the attitude.

Clause 17. The UE of clause 16, wherein the roll estimate and the pitch estimate are determined based on one or more extended Kalman filter (EKF) states.

Clause 18. The UE of clause 17, wherein a velocity estimate of the one or more EKF states is updated based on the validated heading.

Clause 19. The UE of any of clauses 17 to 18, wherein a position estimate of the one or more EKF states is propagated using the sensor information and the estimate of the attitude.

Clause 20. The UE of any of clauses 17 to 19, wherein the one or more EKF states are based on one or more initialization and constraints parameters.

Clause 21. The UE of clause 20, wherein: the one or more initialization and constraints parameters comprise a trajectory of the UE, and the trajectory of the UE is based on the sensor information.

Clause 22. The UE of any of clauses 15 to 21, wherein the validated heading is further based on global navigation satellite system (GNSS) measurements obtained by the UE and the sensor information from the one or more environmental sensors of the UE.

Clause 23. The UE of clause 22, wherein the at least one processor configured to determine the validated heading of the UE comprises the at least one processor configured to: determine that a first heading of the UE determined based on the navigational map data is consistent with a second heading of the UE determined based on the GNSS measurements and the sensor information.

Clause 24. The UE of any of clauses 22 to 23, wherein the GNSS measurements comprise: pseudo range (PR), pseudo range rate (PRR), carrier phase, or any combination thereof.

Clause 25. The UE of any of clauses 15 to 24, wherein the one or more environmental sensors comprise: an accelerometer, a gyroscope, a camera, a radar, a lidar, or any combination thereof.

Clause 26. The UE of any of clauses 15 to 25, wherein the at least one processor is further configured to: display a route of the UE on a user interface of the UE, wherein the route of the UE is overlaid on a map displayed on the user interface of the UE, and wherein the route of the UE includes the dead reckoning position estimate of the UE.

Clause 27. The UE of any of clauses 15 to 26, wherein the UE does not have GNSS service during the determination of the dead reckoning position estimate.

Clause 28. The UE of any of clauses 15 to 27, wherein the UE comprises: a handheld UE, or an on-board computer of a vehicle.

Clause 29. A user equipment (UE), comprising: means for determining a validated heading of the UE, wherein the validated heading is determined based on at least navigational map data stored in a memory of the UE; and means for determining a dead reckoning position estimate of the UE based on at least the validated heading and sensor information from one or more environmental sensors of the UE.

Clause 30. The UE of clause 29, wherein the means for determining the dead reckoning position estimate comprises: means for determining an estimate of an attitude of the UE, wherein the estimate of the attitude is determined based on a roll estimate, a pitch estimate, and a yaw estimate of the UE, and wherein the yaw estimate is based on the validated heading; and means for determining the dead reckoning position estimate based on at least the sensor information and the estimate of the attitude.

Clause 31. The UE of clause 30, wherein the roll estimate and the pitch estimate are determined based on one or more extended Kalman filter (EKF) states.

Clause 32. The UE of clause 31, wherein a velocity estimate of the one or more EKF states is updated based on the validated heading.

Clause 33. The UE of any of clauses 31 to 32, wherein a position estimate of the one or more EKF states is propagated using the sensor information and the estimate of the attitude.

Clause 34. The UE of any of clauses 31 to 33, wherein the one or more EKF states are based on one or more initialization and constraints parameters.

Clause 35. The UE of clause 34, wherein: the one or more initialization and constraints parameters comprise a trajectory of the UE, and the trajectory of the UE is based on the sensor information.

Clause 36. The UE of any of clauses 29 to 35, wherein the validated heading is further based on global navigation satellite system (GNSS) measurements obtained by the UE and the sensor information from the one or more environmental sensors of the UE.

Clause 37. The UE of clause 36, wherein the means for determining the validated heading of the UE comprises: means for determining that a first heading of the UE determined based on the navigational map data is consistent with a second heading of the UE determined based on the GNSS measurements and the sensor information.

Clause 38. The UE of any of clauses 36 to 37, wherein the GNSS measurements comprise: pseudo range (PR), pseudo range rate (PRR), carrier phase, or any combination thereof.

Clause 39. The UE of any of clauses 29 to 38, wherein the one or more environmental sensors comprise: an accelerometer, a gyroscope, a camera, a radar, a lidar, or any combination thereof.

Clause 40. The UE of any of clauses 29 to 39, further comprising: means for displaying a route of the UE on a user interface of the UE, wherein the route of the UE is overlaid on a map displayed on the user interface of the UE, and wherein the route of the UE includes the dead reckoning position estimate of the UE.

Clause 41. The UE of any of clauses 29 to 40, wherein the UE does not have GNSS service during the determination of the dead reckoning position estimate.

Clause 42. The UE of any of clauses 29 to 41, wherein the UE comprises: a handheld UE, or an on-board computer of a vehicle.

Clause 43. A non-transitory computer-readable medium storing computer-executable instructions that, when executed by a user equipment (UE), cause the UE to: determine a validated heading of the UE, wherein the validated heading is determined based on at least navigational map data stored in a memory of the UE; and determine a dead reckoning position estimate of the UE based on at least the validated heading and sensor information from one or more environmental sensors of the UE.

Clause 44. The non-transitory computer-readable medium of clause 43, wherein the computer-executable instructions that, when executed by the UE, cause the UE to determine the dead reckoning position estimate comprise computer-executable instructions that, when executed by the UE, cause the UE to: determine an estimate of an attitude of the UE, wherein the estimate of the attitude is determined based on a roll estimate, a pitch estimate, and a yaw estimate of the UE, and wherein the yaw estimate is based on the validated heading; and determine the dead reckoning position estimate based on at least the sensor information and the estimate of the attitude.

Clause 45. The non-transitory computer-readable medium of clause 44, wherein the roll estimate and the pitch estimate are determined based on one or more extended Kalman filter (EKF) states.

Clause 46. The non-transitory computer-readable medium of clause 45, wherein a velocity estimate of the one or more EKF states is updated based on the validated heading.

Clause 47. The non-transitory computer-readable medium of any of clauses 45 to 46, wherein a position estimate of the one or more EKF states is propagated using the sensor information and the estimate of the attitude.

Clause 48. The non-transitory computer-readable medium of any of clauses 45 to 47, wherein the one or more EKF states are based on one or more initialization and constraints parameters.

Clause 49. The non-transitory computer-readable medium of clause 48, wherein: the one or more initialization and constraints parameters comprise a trajectory of the UE, and the trajectory of the UE is based on the sensor information.

Clause 50. The non-transitory computer-readable medium of any of clauses 43 to 49, wherein the validated heading is further based on global navigation satellite system (GNSS) measurements obtained by the UE and the sensor information from the one or more environmental sensors of the UE.

Clause 51. The non-transitory computer-readable medium of clause 50, wherein the computer-executable instructions that, when executed by the UE, cause the UE to determine the validated heading of the UE comprise computer-executable instructions that, when executed by the UE, cause the UE to: determine that a first heading of the UE determined based on the navigational map data is consistent with a second heading of the UE determined based on the GNSS measurements and the sensor information.

Clause 52. The non-transitory computer-readable medium of any of clauses 50 to 51, wherein the GNSS measurements comprise: pseudo range (PR), pseudo range rate (PRR), carrier phase, or any combination thereof.

Clause 53. The non-transitory computer-readable medium of any of clauses 43 to 52, wherein the one or more environmental sensors comprise: an accelerometer, a gyroscope, a camera, a radar, a lidar, or any combination thereof.

Clause 54. The non-transitory computer-readable medium of any of clauses 43 to 53, further comprising computer-executable instructions that, when executed by the UE, cause the UE to: display a route of the UE on a user interface of the UE, wherein the route of the UE is overlaid on a map displayed on the user interface of the UE, and wherein the route of the UE includes the dead reckoning position estimate of the UE.

Clause 55. The non-transitory computer-readable medium of any of clauses 43 to 54, wherein the UE does not have GNSS service during the determination of the dead reckoning position estimate.

Clause 56. The non-transitory computer-readable medium of any of clauses 43 to 55, wherein the UE comprises: a handheld UE, or an on-board computer of a vehicle.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless positioning performed by a user equipment (UE), comprising:
determining a validated heading of the UE, wherein the validated heading is determined based on at least navigational map data stored in a memory of the UE; and
determining a dead reckoning position estimate of the UE based on at least the validated heading and sensor information from one or more environmental sensors of the UE.

2. The method of claim 1, wherein determining the dead reckoning position estimate comprises:
determining an estimate of an attitude of the UE, wherein the estimate of the attitude is determined based on a roll estimate, a pitch estimate, and a yaw estimate of the UE, and wherein the yaw estimate is based on the validated heading; and
determining the dead reckoning position estimate based on at least the sensor information and the estimate of the attitude.

3. The method of claim 2, wherein the roll estimate and the pitch estimate are determined based on one or more extended Kalman filter (EKF) states.

4. The method of claim 3, wherein a velocity estimate of the one or more EKF states is updated based on the validated heading.

5. The method of claim 3, wherein a position estimate of the one or more EKF states is propagated using the sensor information and the estimate of the attitude.

6. (canceled)

7. The method of claim 3, wherein:
the one or more EKF states are based on one or more initialization and constraints parameters;
the one or more initialization and constraints parameters comprise a trajectory of the UE, and
the trajectory of the UE is based on the sensor information.

8. The method of claim 1, wherein the validated heading is further based on global navigation satellite system (GNSS) measurements obtained by the UE and the sensor information from the one or more environmental sensors of the UE.

9. The method of claim 8, wherein determining the validated heading of the UE comprises:
determining that a first heading of the UE determined based on the navigational map data is consistent with a second heading of the UE determined based on the GNSS measurements and the sensor information.

10. The method of claim 8, wherein the GNSS measurements comprise:
pseudo range (PR),
pseudo range rate (PRR),
carrier phase, or
any combination thereof.

11. (canceled)

12. (canceled)

13. (canceled)

14. (canceled)

15. A user equipment (UE), comprising:
a memory;
at least one transceiver; and
at least one processor communicatively coupled to the memory and the at least one transceiver, the at least one processor configured to:
determine a validated heading of the UE, wherein the validated heading is determined based on at least navigational map data stored in a memory of the UE; and
determine a dead reckoning position estimate of the UE based on at least the validated heading and sensor information from one or more environmental sensors of the UE.

16. The UE of claim 15, wherein the at least one processor configured to determine the dead reckoning position estimate comprises the at least one processor configured to:
determine an estimate of an attitude of the UE, wherein the estimate of the attitude is determined based on a roll estimate, a pitch estimate, and a yaw estimate of the UE, and wherein the yaw estimate is based on the validated heading; and
determine the dead reckoning position estimate based on at least the sensor information and the estimate of the attitude.

17. The UE of claim 16, wherein the roll estimate and the pitch estimate are determined based on one or more extended Kalman filter (EKF) states.

18. The UE of claim 17, wherein a velocity estimate of the one or more EKF states is updated based on the validated heading.

19. The UE of claim 17, wherein a position estimate of the one or more EKF states is propagated using the sensor information and the estimate of the attitude.

20. (canceled)

21. The UE of claim 17, wherein:
the one or more EKF states are based on one or more initialization and constraints parameters;
the one or more initialization and constraints parameters comprise a trajectory of the UE, and
the trajectory of the UE is based on the sensor information.

22. The UE of claim 15, wherein the validated heading is further based on global navigation satellite system (GNSS) measurements obtained by the UE and the sensor information from the one or more environmental sensors of the UE.

23. The UE of claim 22, wherein the at least one processor configured to determine the validated heading of the UE comprises the at least one processor configured to:
determine that a first heading of the UE determined based on the navigational map data is consistent with a second heading of the UE determined based on the GNSS measurements and the sensor information.

24. The UE of claim 22, wherein the GNSS measurements comprise:
pseudo range (PR),
pseudo range rate (PRR),
carrier phase, or
any combination thereof.

25. The UE of claim 15, wherein the one or more environmental sensors comprise:
an accelerometer,
a gyroscope,
a camera,
a radar,
a lidar, or
any combination thereof.

26. (canceled)

27. (canceled)

28. (canceled)

29. A user equipment (UE), comprising:
means for determining a validated heading of the UE, wherein the validated heading is determined based on at least navigational map data stored in a memory of the UE; and
means for determining a dead reckoning position estimate of the UE based on at least the validated heading and sensor information from one or more environmental sensors of the UE.

30. (canceled)
